(19) United States
(12) Patent Application Publication
(10) Pub. No.: US 2021/0334358 A1
(43) Pub. Date: Oct. 28, 2021

(54) CLOUD-BASED DYNAMIC EXECUTABLE VERIFICATION

(71) Applicant: ARRIS Enterprises LLC, Suwanee, GA (US)

(72) Inventors: Alexander Medvinsky, San Diego, CA (US); Rafie Shamsaasef, San Diego, CA (US); Lex A. Anderson, Auckland (NZ)

(21) Appl. No.: 17/242,084

(22) Filed: Apr. 27, 2021

Related U.S. Application Data
(60) Provisional application No. 63/016,134, filed on Apr. 27, 2020.

(51) Int. Cl. G06F 21/51; H04L 9/32; G06F 21/64; G06F 21/44

(52) U.S. Cl. CPC G06F 21/51; G06F 21/44; G06F 21/64; H04L 9/3247

(57) ABSTRACT

A method and system provide the ability to dynamically verify an executable. Encrypted build data and developer permissions are received from a first developer into a build registration tool within a secure cloud computing environment. The encrypted build data includes a build identification (ID), a dynamic code signing certificate (CER), and developer credentials. The build registration tool authenticates the developer credentials based on developer permissions. A dynamic code signing tool (within the secure cloud computing environment) decrypts the encrypted build data and activates the executable by dynamically signing the executable to obtain a dynamic code signature (SEC). The SEC is delivered for runtime deployment.

### CROSS-REFERENCE TO RELATED APPLICATIONS

This application claims the benefit of priority under 35 U.S.C. § 119(e) to U.S. Provisional Application No. 63/016,134, filed on Apr. 27, 2020. This application is also related to the following co-pending and commonly-assigned patent applications, which are incorporated by reference herein in their entirety:

United States Patent Application Publication No. 20170323120, application Ser. No. 15/589,976, filed on May 8, 2017, U.S. Pat. No. 10,503,931 issued on Dec. 10, 2019, by Lex Aaron Anderson, entitled “Method and Apparatus for Dynamic Executable Verification”, which applications claims priority to provisional application No. 62/333,332, filed on May 9, 2016, which is incorporated by reference herein.

### BACKGROUND

### 1. Field

The present disclosure relates to systems and methods for generating and executing executables, and in particular to a system and method for generating and executing dynamically verifiable executables on the cloud.

### 2. Description of the Related Art

Prior art software security systems (e.g., as described in U.S. Pat. No. 10,503,931) provide a set of software security tools that may be used to secure applications when hardware security is not available. One prior art tool adds dynamic runtime code signature validation, where random pieces of code are signed and obfuscated hidden code within the application checks those signatures at runtime. Any attempt to make illegal modifications to the code is caught and the application will take appropriate pre-defined action such as stopping execution, reducing functionality or sending an alert to a security administrator. However, the prior art solution relies on a secure build environment where a privileged individual (e.g., developer) has possession of a confidential dynamic code signing certificate (CER) file containing a signing private key and certificate that are utilized to generate many signatures over code segments—the output of that is a dynamic code signature (SEC) file that will be used to validate random code pieces at runtime. If the CER file somehow leaks out, then an unauthorized party can make their own changes to the binary code, tweak the application in an illegal manner and then use that CER file to generate a set of signatures in the form of their own SEC file. Thereafter, an application with unauthorized changes will be able to execute. Accordingly, it is desirable to prevent such an attack when a CER file leaks out.

To better understand the problems of the prior, a description of the prior art dynamic executable verification may be useful. FIG. 1 illustrates the dynamic executable verification process of the prior art. The different stages of application/executable development and execution are represented by the different columns—build-time 102, link-time 104, executable/application activation 106, and (non-secure) runtime 108. At step 110, dynamic executable verification is added to an application/source 112 at build-time 102 to protect against tampering before and during runtime 108. The dynamic tamper protection tool 114 generates protected binaries 116 along with a dynamic code signing certificate (CER) 118. The tamper detection code in the protected binaries 116 is stealthy, diverse and spread throughout the application 112 to mitigate discovery and circumvention of the tamper protection mechanics. Unlike a static code signing certificate, the CER 118 allows signing of dynamic code blocks within an executable to activate dynamic executable verification of that application 112. In other words, random pieces/blocks of code in random locations are hashed and signed in a manner such that the executable self-verifies the code later during execution/runtime. The executable binary 130 remains unchained from the linking stage of 122, through the activation stage 106 to the runtime 108 stage. The SEC 132 file generated during the activation 106 contains the dynamic code signatures of the protected parts of the executable binary. If the instrumented executable binary 130 doesn't have access to SEC 132 file in the runtime, or if the signature verification fails due to static or dynamic tampering with the SEC 132 or with the executable binary code itself, the executable will enter a failure mode that causes runtime execution to stop.

Linking 120 (during link-time 104) is done by a standard linker 122, which may incorporate unprotected binaries 124 built by other toolchains 126.

At step 128, activation 106 of dynamic executable verification is achieved by the executable 130 using the CER 118 to self-sign. This may be done in a secure environment to prevent the certificate 118 from being leaked. If the certificate 118 is valid and matches the protected portions 116 of the executable 130, it generates a dynamic code signature (SEC) 132 to be deployed along with the executable 130 to the runtime environment 108. The executable 130 is unchanged post-linking 134. This ensures maximum compatibility with sandboxed runtimes and traditional code-signing methods. Thus, during each activation, the random locations of code within the executable are verified, and then a key is used to sign the verified code block (i.e., e.g., producing the SEC).

At step 136, a runtime 108 failure mode may be triggered if the executable 130 or the SEC 132 has been tampered with in any way before or during execution.

In view of the above, in the prior art, during activation 106, the CER 118 is used to generate the signature/SEC 132. In this regard, during activation 106, a search for the CER 118 is conducted, and if found, the executable 130 self-signs itself and produces the SEC 132. Thereafter, the CER 118 may be discarded securely so that during runtime 108, the only thing used/accessed is the executable 130 and SEC 132.

While the above-described prior art implementation may provide some security, it has various problems. For example, if the CER 118 is not handled securely, an attacker can use the CER 118 to sign an executable containing modified code of their choosing. Such an executable 130 along with the resulting dynamic code signature (SEC) 132 will then be able to operate as if it were legitimate. In addition, the exposure of the CER 118 and lack of an authenticated permissions structure allows unauthorized parties to sign executables that may not be ready for production deployment. Further, failed activation attempts may go unnoticed unless the activation environment is specifically set up to monitor for failed activation.

Consequently, the prior art has many problems and is deficient in provided the desired level of security throughout the produced development lifecycle.

### SUMMARY OF THE INVENTION

To overcome the problems of the prior art, embodiments of the invention introduce a new architecture with a secure cloud service that can protect the CER file, restrict access to the CER file and the activation of executables only to authorized personnel with proper credentials. In particular, embodiments of the invention provide a cloud-based dynamic code signing service that securely handles dynamic executable verification activation requests.

The cloud-based dynamic code signing service consists of two alternative embodiments: (1) cloud virtual machine-based activation (also referred to as cloud-based dynamic executable verification); and (2) local activation utilizing cloud-based code signing (also referred to as cloud-based dynamic executable verification without a cloud virtual machine). The service interacts with other cloud-based security services to offer detailed reporting, metrics, and security alerts including detailed tamper protection coverage, activation failures, and runtime metrics.

Further, in embodiments of the invention, cloud-based dynamic code signing cannot be carried out by developers without cloud credentials or with insufficient permissions. A correctly defined permissions structure ensures that only parties with the appropriate credentials can request dynamic signing for production deployment and that signing will only be permitted for applications built with valid developer credentials. In addition, embodiments are configured such that there is no path to input manually generated CERs from non-cloud tamper protection tools into the cloud-based dynamic code signing. Such a design prevents unauthorized developers from signing executables for production deployment.

### BRIEF DESCRIPTION OF THE DRAWINGS

Referring now to the drawings in which like reference numbers represent corresponding parts throughout:

FIG. 1 illustrates the dynamic executable verification process of the prior art;

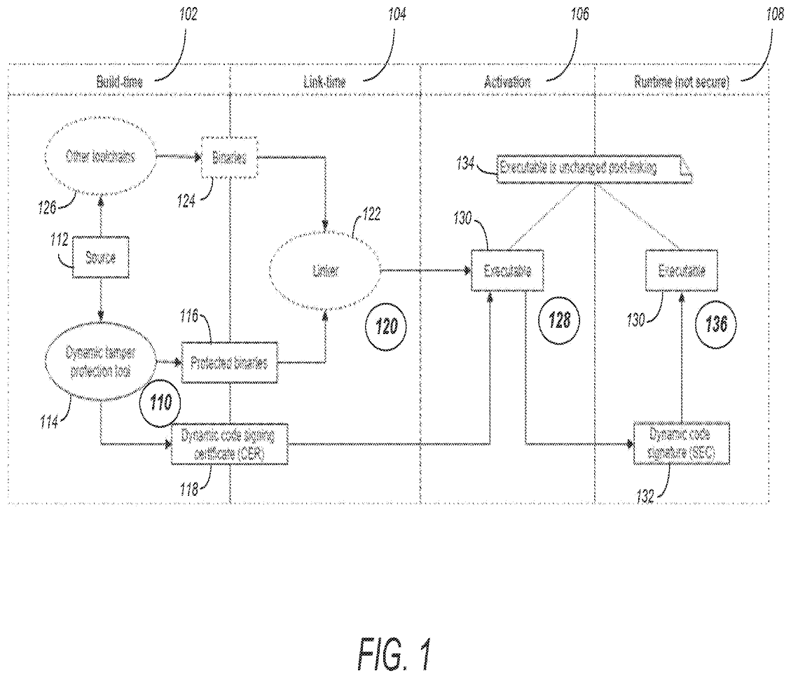

FIG. 2 illustrates the workflow for conducting cloud-based virtual machine (VM) dynamic executable verification in accordance with one or more embodiments of the invention;

FIG. 3 illustrates the workflow for conducting cloud-based dynamic executable verification without a cloud virtual machine in accordance with one or more embodiments of the invention;

FIG. 4 illustrates the general logical flow for dynamically verifying an executable in accordance with one or more embodiments of the invention;

FIG. 5 is an exemplary hardware and software environment used to implement one or more embodiments of the invention; and

FIG. 6 schematically illustrates a typical distributed/cloud-based computer system using a network to connect client computers to server computers in accordance with one or more embodiments of the invention.

### DETAILED DESCRIPTION

In the following description, reference is made to the accompanying drawings which form a part hereof, and which is shown, by way of illustration, several embodiments. It is understood that other embodiments may be utilized and structural changes may be made without departing from the scope of the present disclosure.

### Cloud-Based Virtual-Machine Dynamic Executable Verification

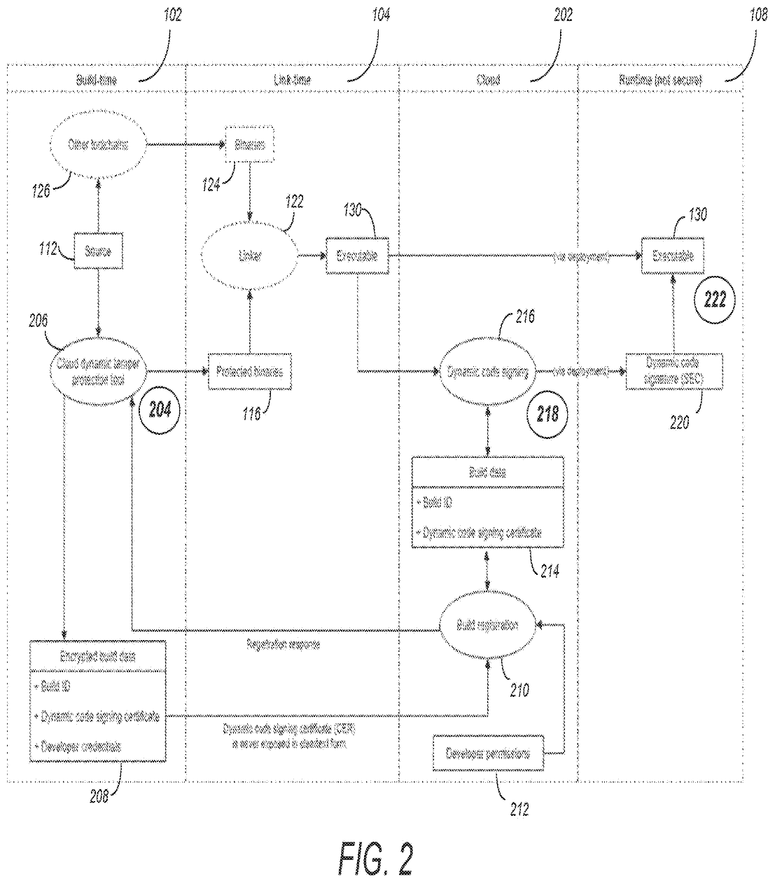

FIG. 2 illustrates the workflow for conducting cloud-based virtual machine (VM) dynamic executable verification in accordance with one or more embodiments of the invention.

At step 204, during build-time 102, the cloud dynamic executable verification tool 206 (also referred to as the cloud dynamic tamper protection tool) securely sends encrypted build data 208 to the build registration cloud endpoint 210. The encrypted build data 208 may include a unique build ID, dynamic code signing certificate (CER), and developer credentials. In one or more embodiments, the build registration cloud endpoint 210 authenticates the user's credentials (e.g., based on developer permissions 212) before accepting the build ID and CER over an encrypted link (e.g., using user name/password, digital certificate, one-time password, etc). Thus, as the encrypted build data 208 is securely sent, the CER is never exposed in cleartext form. The build registration 210 sends a failure response if the request is not authentic or the developer credentials are not authorized for dynamic code signing. Such failure responses will abort the tamper protection tool 206 with an error condition and will result in a failure to build the executable binary at the build-time 102 stage. Once authenticated, the build data 214 (i.e., that includes the build ID and dynamic code signing certificate (CER), is sent to the dynamic code signing endpoint 216. In this regard, a developer/person with proper credentials may upload the CER, create the build configuration, and upload/transmit both to the cloud (e.g., as part of the encrypted build data 208).

Distinguishable from the prior art, the activation is performed in the cloud 202 at step 218. At activation time, the executable 130 is securely sent to the dynamic code signing endpoint 216 post-linking (i.e., linking is performed by linker 122). An authenticated connection to the dynamic code signing endpoint 216 (e.g., between the linker 122 and dynamic code signing tool 216) is assumed to exist. The cloud service 202 runs the executable 130 in a secure VM hosted in the cloud to obtain a dynamic code signature (SEC) 220. In this regard, the cloud 202 environment is a secure environment (e.g., the VM may execute behind firewalls, has been updated with the latest security patches and armed with an Intrusion Detection System which constantly monitors for security vulnerabilities and network-based threats) where normal developers do not have access. Further, in one or more embodiments, the VM that is launched is for a specific operating system (e.g., ANDROID, WINDOWS, MAC OS X, iOS, etc.). In this regard, the executable 130 can be activated for use in a particular runtime environment. If the executable 130 is invalid, the dynamic code signing fails, or if the developer permissions 212 associated with the build ID are insufficient, the endpoint 216 will abort with an error condition. Otherwise, the endpoint 216 returns the SEC 220 for runtime deployment 108. Note that the dynamic code signing cloud endpoint 216 does not accept a CER as input (i.e., separate from the build data), thus preventing non-cloud protected executables from being signed. Instead, the CER is installed/uploaded by the developer and validated/authenticated as part of the build registration 210.

At step 222, a failure mode will be triggered if the executable 130 or the SEC 220 has been tampered with in any way before or during execution at runtime 108. Note that the executable 130 remains unchanged post-linking.

In view of the above, the cloud dynamic tamper protection tool 206 encrypts build data 208 including developer credentials which is uploaded to the cloud service 202. Preferably, build data is encrypted using a public key of the cloud service 202 such that it can only be decrypted by the cloud service 202 using the matching private key. The build registration 210 then authenticates the developer via developer permissions 212 and passes the build data onto the dynamic code signing endpoint 216. The dynamic code signing endpoint 216 decrypts the encrypted build data which results in clear build data 214 and then launches a VM based on the build data 214 to activate the executable 130 for a particular customer. The dynamic code signing endpoint 216 uses a CER to sign code blocks in the executable 130 (i.e., based on the information specified in the build data 214), and generates the dynamic code signature SEC (i.e., the signed file) which is then returned to the customer for runtime 108. Further, once the CER is uploaded to the cloud service 202, it is not accessible to general developers and instead is just used for activation. In addition, the activation process (e.g., performed by the dynamic code signing tool 216) is performed dynamically during runtime in a secure environment such that only the cloud system is able to perform the activation and properly generates the SEC 220 file that is needed to be deployed with the executable 130 in the non-secure runtime environment (e.g., pursuant to and based on the encrypted build data 208 including developer credentials).

### Local Activation Utilizing Cloud-Based Code Signing

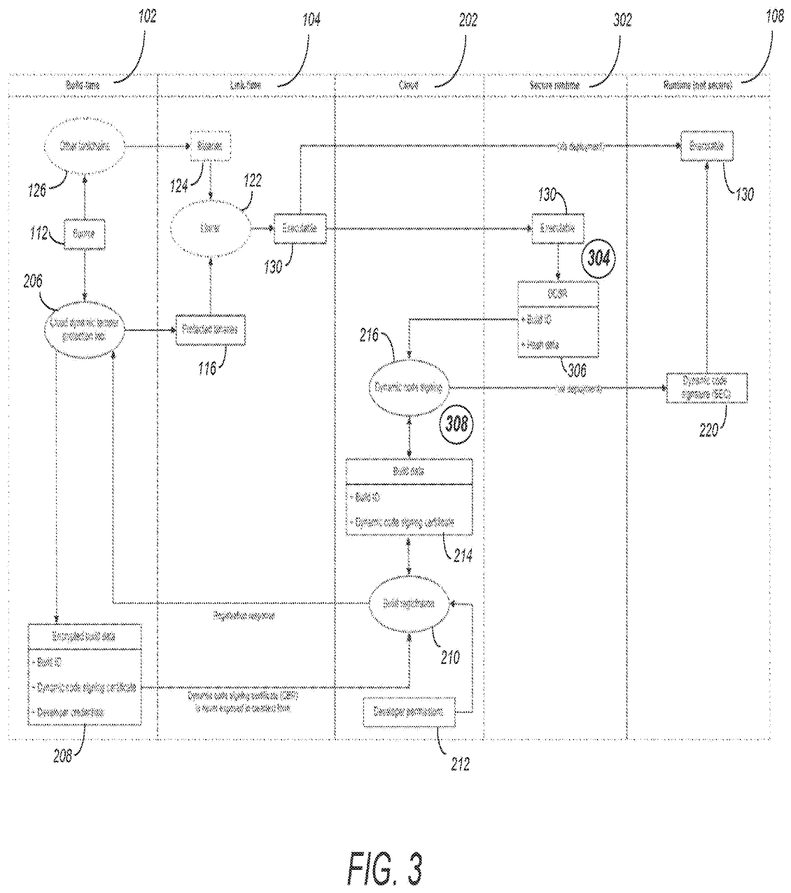

FIG. 3 illustrates the workflow for conducting cloud-based dynamic executable verification without a cloud virtual machine in accordance with one or more embodiments of the invention. As illustrated, many of the same components/steps as that in FIG. 2 are performed (i.e., the build time 102 and link time 104 actions are the same as that of FIG. 2).

In this scenario, the customer sets up a secure runtime environment 302 to carry out step 304. Access to the secure runtime environment 302 may be restricted to only essential personnel authorized by the customer. The customer may be required to deploy a firewall and a runtime Intrusion Detection System in order to secure the runtime environment. In step 304, a linked executable 130 is run to generate a Dynamic Code Signing Request (DCSR) 306. The DCSR 306 is then sent to the dynamic code signing cloud endpoint 216 (via an authenticated connection). For instance, this connection may be authenticated using customer credentials on a hardware cryptographic token or Smart Card that cannot be cloned.

At step 308, the dynamic code signing cloud endpoint 216 evaluates the DCSR 306. Note that an authenticated connection to this endpoint (e.g., between DSCR 306 and dynamic code signing endpoint 216) is assumed to exist. If the request is not authentic, the DCSR 306 is invalid or the developer permissions 212 associated with the build ID are insufficient (e.g., as determined during the build registration 210), the endpoint 216 will abort with an error condition. Otherwise the endpoint 216 returns a dynamic code signature (SEC) 220 for runtime deployment (e.g., in the insecure runtime 108). As with the base scenario of FIG. 2, the executable 130 remains unchanged post-linking. Further, similar to the base scenario of FIG. 2, the dynamic code signing cloud endpoint 216 does not accept a CER as input, thus preventing non-cloud protected executables from being signed.

In view of the above, it may be noted that in both of the scenarios (i.e., of FIG. 2 and FIG. 3), the CER file is still protected by the cloud service 202. Further, the developer runs the initial build (e.g., generated the build data 208) based on the source code 112 to generate the code with sections/blocks that are protected and the build data is uploaded to the cloud 202. However, unlike the scenario of FIG. 2, in the FIG. 3 scenario, the cloud 202 does not actually run the executable (e.g., in a VR). Instead, the cloud 202 protects the CER file and activates the executable 130 with the CER and returns back the SEC to the developer/customer for runtime. The executable 130 is not changed during this process. In addition, the hashes (i.e., in DSCR 306) are uploaded to the dynamic code signing endpoint 216 (in the cloud 202) during runtime 302. Accordingly, the result from the cloud 202 is the same—an SEC 220 is provided to the developer/customer for runtime 108 execution. Thus, in the base scenario of FIG. 2, the cloud 202 gets the executable and runs it in the cloud while in the scenario of FIG. 3, the cloud 202 gets the set of hashes (i.e., hash data as part of the DCSR 306), and signs the hashes instead of running the executable. As illustrated, unsecured runtime 108 is not part of the cloud service 202 under either scenario. The hash data is a cryptographic hash of each of the protected functions within the binary executable 130. This hash is later used to create the SEC 220 file, which is equivalent to a dynamic code signature for the protected parts of the executable.

### General Logical Flow

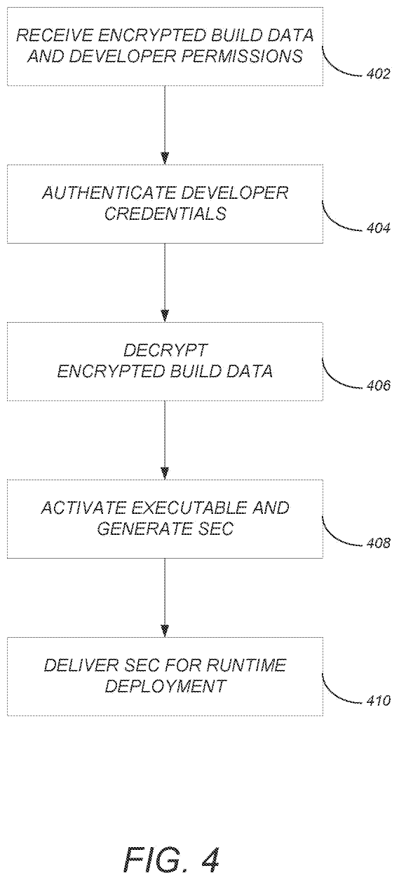

FIG. 4 illustrates the general logical flow for dynamically verifying an executable in accordance with one or more embodiments of the invention.

At step 402, encrypted build data and developer permissions are received from a first developer (into a build registration tool within a secure cloud computing environment). The encrypted build data includes a build identification (ID), a dynamic code signing certificate (CER), and developer credentials.

At step 404, the developer credentials are authenticated (in the build registration tool), based on developer permissions. In one or more embodiments, the build registration tool determines that developer credentials from a second developer are not authorized for dynamic code signing, and sends a failure response to a cloud dynamic tamper protection tool (the failure response aborts the tamper protection tool with an error condition).

At step 406, the encrypted build data is decrypted into clear build data.

At step 408, the executable is activated, in a dynamic code signing tool within the secure cloud computing environment, by dynamically signing the executable to obtain a dynamic code signature (SEC). During the activation, the secure cloud computing environment may run the executable in a virtual machine (VM) to obtain the SEC. In one or more embodiments, the dynamic code signing tool determines that the executable is invalid, fails to dynamically sign the executable, or that developer permissions (in the received developer permissions that are associated with the build ID) are insufficient. As a result of such a determination, the dynamic code signing tool may abort the activating with an error condition.

In embodiments of a second scenario, a dynamic code signing request (DCSR) may be received (in the dynamic code signing tool), from a customer secure runtime environment. Such a customer secure runtime environment runs the executable to generate the DCSR. Thereafter, the DCSR is evaluated in the dynamic code signing tool. Based on evaluation, the SEC is returned for runtime deployment. In one or more embodiments, the evaluation determines that the DCSR is not authentic, invalid, or developer permissions are insufficient, and as a result, the dynamic code signing tool aborts with an error condition.

At step 410, the SEC is delivered for runtime deployment. In one or more embodiments, a protected executable may be launched in a non-secure runtime. The protected executable locates the SEC file. Thereafter, the validation of the executable signature SEC or of one of the many code segment hashes covered by the signature may be failed. Such a failure leads to a determination that the SEC has been tampered with. As a result, a failure mode may be triggered. In other words, during the validation of the executable signature during runtime, if it is determined that the SEC has been tampered with, a failure mode may be triggered.

### Hardware Environment

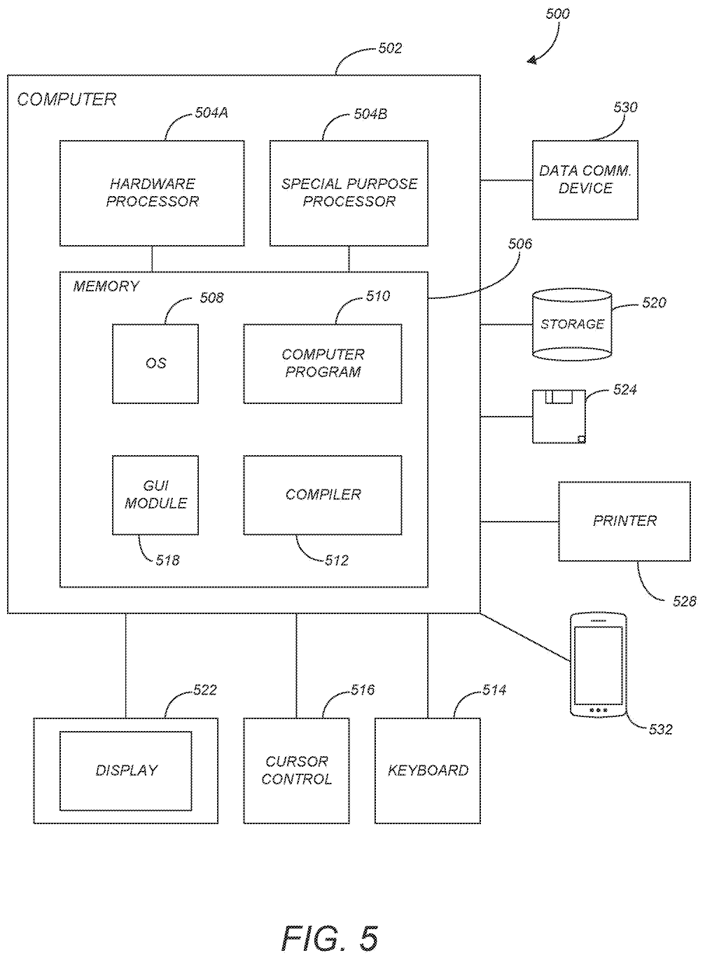

FIG. 5 is an exemplary hardware and software environment 500 (referred to as a computer-implemented system and/or computer-implemented method) used to implement one or more embodiments of the invention. The hardware and software environment includes a computer 502 and may include peripherals. Computer 502 may be a user/client computer, server computer, or may be a database computer. The computer 502 comprises a hardware processor 504A and/or a special purpose hardware processor 504B (hereinafter alternatively collectively referred to as processor 504) and a memory 506, such as random access memory (RAM). The computer 502 may be coupled to, and/or integrated with, other devices, including input/output (I/O) devices such as a keyboard 514, a cursor control device 516 (e.g., a mouse, a pointing device, pen and tablet, touch screen, multi-touch device, etc.) and a printer 528. In one or more embodiments, computer 502 may be coupled to, or may comprise, a portable or media viewing/listening device 532 (e.g., an MP3 player, IPOD, NOOK, portable digital video player, cellular device, personal digital assistant, etc.). In yet another embodiment, the computer 502 may comprise a multi-touch device, mobile phone, gaming system, internet enabled television, television set top box, or other internet enabled device executing on various platforms and operating systems.

In one embodiment, the computer 502 operates by the hardware processor 504A performing instructions defined by the computer program 510 (e.g., a computer-aided design [CAD] application) under control of an operating system 508. The computer program 510 and/or the operating system 508 may be stored in the memory 506 and may interface with the user and/or other devices to accept input and commands and, based on such input and commands and the instructions defined by the computer program 510 and operating system 508, to provide output and results.

Output/results may be presented on the display 522 or provided to another device for presentation or further processing or action. In one embodiment, the display 522 comprises a liquid crystal display (LCD) having a plurality of separately addressable liquid crystals. Alternatively, the display 522 may comprise a light emitting diode (LED) display having clusters of red, green and blue diodes driven together to form full-color pixels. Each liquid crystal or pixel of the display 522 changes to an opaque or translucent state to form a part of the image on the display in response to the data or information generated by the processor 504 from the application of the instructions of the computer program 510 and/or operating system 508 to the input and commands. The image may be provided through a graphical user interface (GUI) module 518. Although the GUI module 518 is depicted as a separate module, the instructions performing the GUI functions can be resident or distributed in the operating system 508, the computer program 510, or implemented with special purpose memory and processors.

In one or more embodiments, the display 522 is integrated with/into the computer 502 and comprises a multi-touch device having a touch sensing surface (e.g., track pod or touch screen) with the ability to recognize the presence of two or more points of contact with the surface. Examples of multi-touch devices include mobile devices (e.g., IPHONE, NEXUS S, DROID devices, etc.), tablet computers (e.g., IPAD, HP TOUCHPAD, SURFACE Devices, etc.), portable/handheld game/music/video player/console devices (e.g., IPOD TOUCH, MP3 players, NINTENDO SWITCH, PLAYSTATION PORTABLE, etc.), touch tables, and walls (e.g., where an image is projected through acrylic and/or glass, and the image is then backlit with LEDs).

Some or all of the operations performed by the computer 502 according to the computer program 510 instructions may be implemented in a special purpose processor 504B. In this embodiment, some or all of the computer program 510 instructions may be implemented via firmware instructions stored in a read only memory (ROM), a programmable read only memory (PROM) or flash memory within the special purpose processor 504B or in memory 506. The special purpose processor 504B may also be hardwired through circuit design to perform some or all of the operations to implement the present invention. Further, the special purpose processor 504B may be a hybrid processor, which includes dedicated circuitry for performing a subset of functions, and other circuits for performing more general functions such as responding to computer program 510 instructions. In one embodiment, the special purpose processor 504B is an application specific integrated circuit (ASIC).

The computer 502 may also implement a compiler 512 that allows an application or computer program 510 written in a programming language such as C, C++, Assembly, SQL, PYTHON, PROLOG, MATLAB, RUBY, RAILS, HASKELL, or other language to be translated into processor 504 readable code. Alternatively, the compiler 512 may be an interpreter that executes instructions/source code directly, translates source code into an intermediate representation that is executed, or that executes stored precompiled code. Such source code may be written in a variety of programming languages such as JAVA, JAVASCRIPT, PERL, BASIC, etc. After completion, the application or computer program 510 accesses and manipulates data accepted from I/O devices and stored in the memory 506 of the computer 502 using the relationships and logic that were generated using the compiler 512.

The computer 502 also optionally comprises an external communication device such as a modem, satellite link, Ethernet card, or other device for accepting input from, and providing output to, other computers 502.

In one embodiment, instructions implementing the operating system 508, the computer program 510, and the compiler 512 are tangibly embodied in a non-transitory computer-readable medium, e.g., data storage device 520, which could include one or more fixed or removable data storage devices, such as a zip drive, floppy disc drive 524, hard drive, CD-ROM drive, tape drive, etc. Further, the operating system 508 and the computer program 510 are comprised of computer program 510 instructions which, when accessed, read and executed by the computer 502, cause the computer 502 to perform the steps necessary to implement and/or use the present invention or to load the program of instructions into a memory 506, thus creating a special purpose data structure causing the computer 502 to operate as a specially programmed computer executing the method steps described herein. Computer program 510 and/or operating instructions may also be tangibly embodied in memory 506 and/or data communications devices 530, thereby making a computer program product or article of manufacture according to the invention. As such, the terms “article of manufacture,” “program storage device,” and “computer program product,” as used herein, are intended to encompass a computer program accessible from any computer readable device or media.

Of course, those skilled in the art will recognize that any combination of the above components, or any number of different components, peripherals, and other devices, may be used with the computer 502.

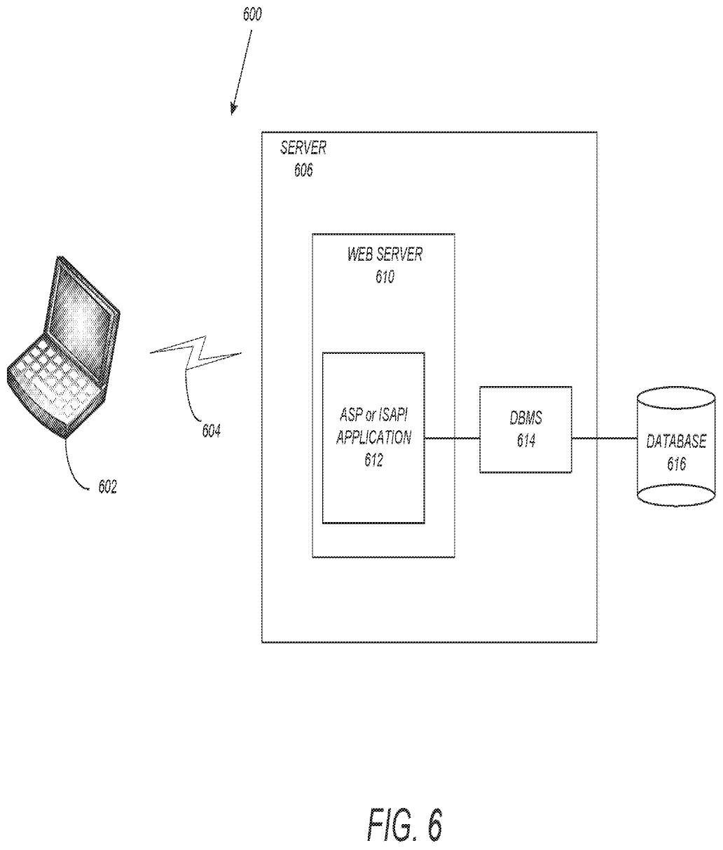

FIG. 6 schematically illustrates a typical distributed/cloud-based computer system 600 using a network 604 to connect client computers 602 to server computers 606. A typical combination of resources may include a network 604 comprising the Internet, LANs (local area networks), WANs (wide area networks), SNA (systems network architecture) networks, or the like, clients 602 that are personal computers or workstations (as set forth in FIG. 5), and servers 606 that are personal computers, workstations, minicomputers, or mainframes (as set forth in FIG. 5). However, it may be noted that different networks such as a cellular network (e.g., GSM [global system for mobile communications] or otherwise), a satellite based network, or any other type of network may be used to connect clients 602 and servers 606 in accordance with embodiments of the invention.

A network 604 such as the Internet connects clients 602 to server computers 606. Network 604 may utilize ethernet, coaxial cable, wireless communications, radio frequency (RF), etc. to connect and provide the communication between clients 602 and servers 606. Further, in a cloud-based computing system, resources (e.g., storage, processors, applications, memory, infrastructure, etc.) in clients 602 and server computers 606 may be shared by clients 602, server computers 606, and users across one or more networks. Resources may be shared by multiple users and can be dynamically reallocated per demand. In this regard, cloud computing may be referred to as a model for enabling access to a shared pool of configurable computing resources. In addition, as describe above, the cloud-based computing system/environment may consist of a secure cloud computing environment such that particular services (e.g., the dynamic code signing) cannot be carried out without cloud credentials or with insufficient permissions. A correctly defined permissions structure ensures that only parties with the appropriate credentials can request dynamic signing for production deployment and that signing will only be permitted for applications build with valid developer credentials.

Clients 602 may execute a client application or web browser and communicate with server computers 606 executing web servers 610. Such a web browser is typically a program such as MICROSOFT INTERNET EXPLORER/EDGE, MOZILLA FIREFOX, OPERA, APPLE SAFARI, GOOGLE CHROME, etc. Further, the software executing on clients 602 may be downloaded from server computer 606 to client computers 602 and installed as a plug-in or ACTIVEX control of a web browser. Accordingly, clients 602 may utilize ACTIVEX components/component object model (COM) or distributed COM (DCOM) components to provide a user interface on a display of client 602. The web server 610 is typically a program such as MICROSOFT'S INTERNET INFORMATION SERVER.

Web server 610 may host an Active Server Page (ASP) or Internet Server Application Programming Interface (ISAPI) application 612, which may be executing scripts. The scripts invoke objects that execute business logic (referred to as business objects). The business objects then manipulate data in database 616 through a database management system (DBMS) 614. Alternatively, database 616 may be part of, or connected directly to, client 602 instead of communicating/obtaining the information from database 616 across network 604. When a developer encapsulates the business functionality into objects, the system may be referred to as a component object model (COM) system. Accordingly, the scripts executing on web server 610 (and/or application 612) invoke COM objects that implement the business logic. Further, server 606 may utilize MICROSOFT'S TRANSACTION SERVER (MTS) to access required data stored in database 616 via an interface such as ADO (Active Data Objects), OLE DB (Object Linking and Embedding DataBase), or ODBC (Open DataBase Connectivity).

Generally, these components 600-616 all comprise logic and/or data that is embodied in/or retrievable from device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

Although the terms “user computer”, “client computer”, and/or “server computer” are referred to herein, it is understood that such computers 602 and 606 may be interchangeable and may further include thin client devices with limited or full processing capabilities, portable devices such as cell phones, notebook computers, pocket computers, multi-touch devices, and/or any other devices with suitable processing, communication, and input/output capability.

Of course, those skilled in the art will recognize that any combination of the above components, or any number of different components, peripherals, and other devices, may be used with computers 602 and 606. Embodiments of the invention are implemented as a software/CAD application on a client 602 or server computer 606. Further, as described above, the client 602 or server computer 606 may comprise a thin client device or a portable device that has a multi-touch-based display.

### Conclusion

This concludes the description of the preferred embodiments of the present disclosure. The foregoing description of the preferred embodiment has been presented for the purposes of illustration and description. It is not intended to be exhaustive or to limit the disclosure to the precise form disclosed. Many modifications and variations are possible in light of the above teaching. It is intended that the scope of rights be limited not by this detailed description, but rather by the claims appended hereto.

What is claimed is:

1. A method of dynamically verifying an executable, comprising:
receiving from a first developer, in a build registration tool within a secure cloud computing environment, encrypted build data and developer permissions, wherein the encrypted build data comprises a build identification (ID), a dynamic code signing certificate (CER), and developer credentials;
authenticating, in the build registration tool, the developer credentials based on developer permissions;
decrypting, in a dynamic code signing tool within the secure cloud computing environment, the encrypted build data; and
activating, in the dynamic code signing tool, the executable by dynamically signing the executable to obtain a dynamic code signature (SEC) based on information specified in the build data; and
delivering the SEC for runtime deployment.

2. The method of claim 1, wherein the activating further comprises:
the secure cloud computing environment running the executable in a virtual machine (VM) to obtain the SEC.

3. The method of claim 1, further comprising:
the build registration tool determining that developer credentials from a second developer are not authorized for dynamic code signing; and
sending a failure response to a cloud dynamic tamper protection tool, wherein the failure response aborts the tamper protection tool with an error condition.

4. The method of claim 1, further comprising:
the dynamic code signing tool determining that the executable is invalid; and
the dynamic code signing tool aborting the activating with an error condition.

5. The method of claim 1, further comprising:
the dynamic code signing tool failing to dynamically sign the executable; and
the dynamic code signing tool aborting the activating with an error condition.

6. The method of claim 1, further comprising:
the dynamic code signing tool determining which developer permissions in the developer permissions are associated with the build ID;
the dynamic code signing tool determining whether the developer permissions associated with the build ID are sufficient; and
the dynamic code signing tool aborting the activating with an error condition when insufficient.

7. The method of claim 1, further comprising:
launching a protected executable in a non-secure runtime;
the protected executable locating the SEC;
failing a validation of the SEC or of one or more code segment hashes covered by the SEC;
based on the failing, determining that the SEC has been tampered with; and
triggering a failure mode based on upon the determining.

8. The method of claim 1, further comprising:
receiving, in the dynamic code signing tool, a dynamic code signing request (DCSR) from a customer secure runtime environment, wherein the customer secure runtime environment runs the executable to generate the DCSR; and
evaluating, in the dynamic code signing tool, the DCSR, wherein based on the evaluating, the SEC is returned for runtime deployment.

9. The method of claim 8, wherein:
the evaluating determines that the DCSR is not authentic, invalid, or developer permissions are insufficient; and
the dynamic code signing tool aborts with an error condition.

10. A system for dynamically verifying an executable, comprising:
(a) a secure cloud computing environment having one or more computers;
(b) the one or more computers, wherein each of the one or more computers has a memory and a processor that executes;
(c) a build registration tool executing on one or more of the processors via a first set of instructions stored in one or more of the memories, wherein the build registration tool performs operations comprising:
(i) receiving from a first developer encrypted build data and developer permissions, wherein the encrypted build data comprises a build identification (ID), a dynamic code signing certificate (CER), and developer credentials; and
(ii) authenticating the developer credentials based on developer permissions; and
(d) a dynamic code signing tool executing on one or more of the processors via a second set of instructions stored in one or more of the memories, wherein the dynamic code signing tool performs operations comprising:
(i) decrypting the encrypted build data;
(ii) activating the executable by dynamically signing the executable to obtain a dynamic code signature (SEC) based on information specified in the build data; and
(iii) delivering the SEC for runtime deployment.

11. The system of claim 10, wherein the build registration tool and the dynamic code signing tool execute in a virtual machine (VM).

12. The system of claim 10, wherein the build registration tool further:
determines that developer credentials from a second developer are not authorized for dynamic code signing; and
sends a failure response to a cloud dynamic tamper protection tool, wherein the failure response aborts the tamper protection tool with an error condition.

13. The system of claim 10, wherein the dynamic code signing tool further:
determines that the executable is invalid; and
aborts the activating with an error condition.

14. The system of claim 10, wherein the dynamic code signing tool further:
fails to dynamically sign the executable; and
aborts the activating with an error condition.

15. The system of claim 10, wherein the dynamic code signing tool further:
determines which developer permissions in the developer permissions are associated with the build ID;
determines whether the developer permissions associated with the build ID are sufficient; and
aborts the activating with an error condition when insufficient.

16. The system of claim 10, further comprising a runtime environment, wherein the runtime environment:
launches a protected executable; and
receives the SEC;
determines that the SEC has been tampered with; and
triggers a failure mode based on upon the determining.

17. The system of claim 10, wherein the dynamic code signing tool further:
receives a dynamic code signing request (DCSR) from a customer secure runtime environment, wherein the customer secure runtime environment runs the executable to generate the DCSR;
evaluates the DCSR, wherein based on the evaluating, the SEC is returned for runtime deployment.

18. The system of claim 17, wherein:
the dynamic code signing tool evaluation comprises the DCSR determining that the DCSR is not authentic, invalid, or developer permissions are insufficient; and
the dynamic code signing tool aborts with an error condition.
